(19) United States
(12) Patent Application Publication
(10) Pub. No.: US 2012/0055937 A1
(43) Pub. Date: Mar. 8, 2012

(54) DIFFERENTIALLY ARMORED FUEL TANK STRUCTURE AND ASSOCIATED FABRICATION METHODOLOGY

(75) Inventors: Russell A. Monk, Salem, OR (US); Thomas S. Ohnstad, Salem, OR (US)

(73) Assignee: High Impact Technology, LLC, Tigard, OR (US)

(21) Appl. No.: 13/218,315

(22) Filed: Aug. 25, 2011

Related U.S. Application Data
(60) Provisional application No. 61/380,223, filed on Sep. 4, 2010.

(51) Int. Cl. B60K 15/03; B21D 53/88

(52) U.S. Cl. 220/560.02; 29/897.2

(57) ABSTRACT

Differentially armored, vehicle fuel tank structure possessing contiguous, united and integrated, tank-wall regions including a high-puncture-risk region formed of lightweight, penetrable, non-armoring material, and joined thereto, a low-puncture-risk region formed of hardened and heavyweight, anti-penetration, armoring material. Included also is a sprayed-on, allover, tank-exterior, self-sealing, anti-fuel-leak barrier coating formed principally of a high-elastomeric material which reacts in a material-swelling manner on contact with fuel in the tank structure.

### CROSS REFERENCE TO RELATED APPLICATION

This application claims filing-date priority to U.S. Provisional Patent Application, Ser. No. 61/380,223, filed Sep. 4, 2010, for “Differentially Armored Fuel Tank”, the entire disclosure content in which is hereby incorporated herein by reference.

### BACKGROUND AND SUMMARY OF THE INVENTION

This invention relates to a material-conservative, relatively lightweight, functionally and conceptually reversed (in terms of armoring positioning), differentially armored vehicle fuel tank structure, including a tank of the kind which is mounted and positioned on the frame in a vehicle, such as a military vehicle, in such a way that certain sides, zones, or regions, of the tank are exposed and particularly vulnerable to an “incoming” puncture wound, such as a bullet or shrapnel puncture wound, and that certain other (opposite) sides, etc. are not so exposed. It also relates to methodology for creating such a tank structure.

The tank structure and methodology of the invention result in a practical and satisfactory tank product which is useful in many applications, and which, importantly, blends (a) appropriate armoring suitable for “protection” in a number of selected applications, and (b) resulting lightweightness and associated materials savings.

Various strategies and products have been implemented in the past to armor a vehicle fuel tank against the kind of puncture wound mentioned above, and particularly to armor such a tank in a fashion whereby, if a puncture wound occurs, a mechanism, such as a tank coating, is present in association with the tank which reacts to the initiation of fuel leakage to seal the leakage wound as rapidly as possible. In this prior-art practice, it is typical that the entire outside surface area of a fuel tank is coated with a high-elastomeric-based, leakage-self-healing coating of different, specific, layered types.

This kind of fuel tank coating has proven to be extremely effective in many applications, but it turns out that there are regions in the fuel tank with respect to which an aggressive bullet wound can result, actually, in the creation of two puncture wounds (entry and exit). In this situation, the first puncture wound takes place where a bullet, etc., first strikes a tank structure, and at this location, the typical metal which forms a tank wall fractures and deforms (i.e., flowers, or blossoms) inwardly in a fashion which does not interfere with the ability of an outside, self-sealing coating to close the offending puncture wound. A related, second puncture wound, however, may occur if a striking bullet, etc., has enough energy to penetrate and pass through an opposite wall location in the tank, with respect to which second puncture wound, deformed tank-wall metal is driven outwardly in a fashion creating a jagged flower which then tends to prevent effective self-sealing by a there-existing outside coating of the type generally described.

The present invention addresses this issue by proposing an inherently, differentially armored fuel tank structure (with included tank), referred to herein as a material-conservative (i.e., a material-saving), functionally and conceptually reversed (in terms of traditional armoring positioning) fuel tank structure, wherein the armoring character of the fuel-tank material, per se, typically steel, is differentiated at different locations in the wall of a fuel tank.

More specifically, in accordance with the present, altered-concept, or reversed-concept, invention, what might be thought of as being the vulnerable, exposure sides (potential entry-wound sides), or expanses, zones or regions, of the wall defining a tank are formed with relatively normal, non-hardened, non-armoring steel. However, tank-wall regions (non-direct-strike-exposure expanses, etc.) “opposite” these vulnerable sides are intentionally formed of a thicker, hardened, armoring steel. This arrangement, of course, is the reverse of what is traditionally considered to be the appropriate distribution/positioning of armoring material.

The tank in the tank structure, thus formed with differential tank-wail armoring, is then covered on its outside entirely with a self-sealing coating of the type generally outlined above.

Accordingly, a preferred and best mode embodiment of the invention takes the form of a differentially-armored, altered-armoring-priority, liquid fuel tank structure for a vehicle including (1) a liquid fuel tank having a defining tank wall possessing an outside surface, and both a high-puncture-risk, entry-wound zone, and a low-puncture-risk, exit-wound zone, and in association respectively with these zones, integrated, functionally differentiated, tank-wall regions joined to one another, and including, for the entry-wound zone, a region formed of lightweight, non-armoring material, and for the exit-wound zone, a region formed of heavyweight, armoring material, and (2) distributed over the entirety of the tank wall's outside surface, a self-sealing, anti-puncture-wound-leak, barrier coating formed throughout with a high-elastomeric material which reacts in elastomeric and material-swelling self-sealing manners on contact with leakage fuel coming from the tank.

The barrier coating preferably includes plural layers, in at least one of which there is an embedded distribution of liquid-fuel imbiber beads.

The proposed methodology of the invention includes the steps of (a) forming for the mentioned entry-wound zone a tank-wall region utilizing lightweight, non-armoring material, (b) forming for the mentioned exit-wound zone, in joinder with the first-mentioned formed tank-wall region, another tank-wall region utilizing heavyweight, anti-penetration, armoring material, and (c) jacketing the tank-wall's outside surface with a self-sealing, anti-puncture-wound-leak, barrier coating formed throughout with a high-elastomeric material which reacts in both elastomeric and material-swelling self-sealing manners on contact with leakage fuel coming from the tank.

The method also preferably includes performing the barrier-coating jacketing step so as to create plural layers in it, including in at least one of these layers a distribution of liquid-fuel imbiber beads.

With such a differentially armored tank, while an initial puncture wound may occur in what has been referred to above as being the vulnerable side, or regions, of a tank, wherein such a wound causes tank metal to deform inwardly toward the inside of the tank, a second, egress puncture wound is effectively prevented by the fact that the tank material, per se, at such a second location is formed, in accordance with the present invention, with hardened, armoring steel which tends to turn a striking bullet back into the tank to prevent a second puncture wound.

A reason for not constructing an entire tank with such hardened, armoring material involves keeping tank cost and weight as low as possible.

These and other features and advantages offered by the structure and methodology of the invention will become more fully apparent as the detailed description which follows below is read in conjunction with the drawings.

### DESCRIPTIONS OF THE DRAWINGS

FIG. 1 is a simplified cross-sectional view illustrating a differentially-armored, altered-priority, vehicle fuel tank structure constructed in accordance with a preferred and best-mode embodiment of the present invention.

FIG. 2 is an enlarged, fragmentary cross-section taken generally along the line 2-2 in FIG. 1.

FIG. 3 is an enlarged, fragmentary, cross-section, drawn on about the same scale employed in FIG. 2, and taken generally along the line 3-3 in FIG. 1.

Components shown in these drawing figures are not drawn to scale.

### DETAILED DESCRIPTION OF THE INVENTION

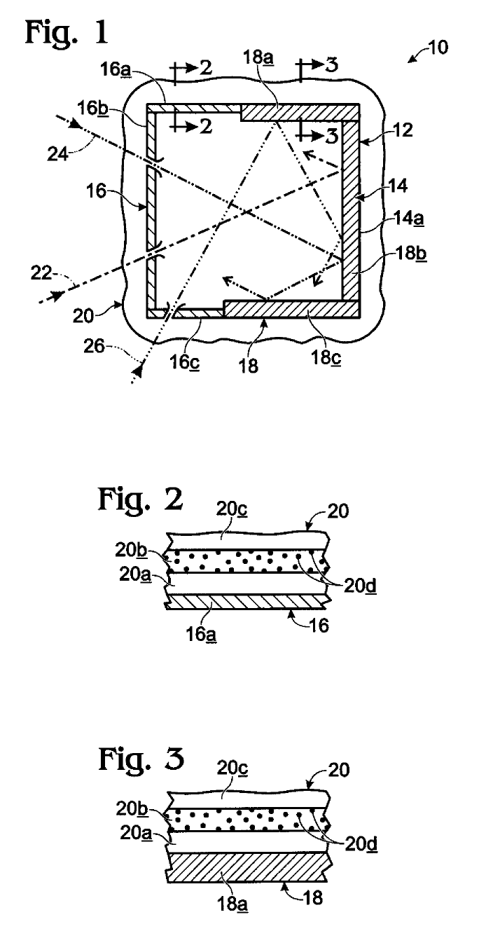

Turning now to the drawings, indicated generally at 10 in FIG. 1 is a differentially-armored, altered-armoring-priority, liquid fuel tank structure for a vehicle, such as a military vehicle, constructed in accordance with a preferred and best-mode embodiment of the present invention. This tank structure which is illustrated cross-sectionally in quite simplified form is fully representative of the tank structure proposed by the invention.

Generally speaking, tank structure 10 herein includes a metal (steel) tank 12 formed by a defining tank wall 14 which has an outside surface 14a, and which possesses two, functionally differentiated tank-wall zones referred to herein as a high-puncture-risk, entry-wound zone 16 (represented as a thin-walled structure in FIG. 1), and a low-puncture-risk, exit-wound zone 18 (represented as a thick-walled structure in the same figure). In association, respectively, with these two zones, wall 14 features integrated, tank-wall regions joined to one another, and including, for entry-wound zone 16 a region formed of lightweight, non-armoring metal (steel) material components 16a, 16b, 16c, and for exit-wound zone 18, a region formed of heavyweight, armoring metal (armoring steel) material components 18a, 18b, 18c.

Preferably, the “normal”, non-armoring steel used in zone 16 is stainless steel, and has a thickness of about 0.125-inches. The armoring steel employed in zone 18 preferably is stainless steel, and has a thickness of about 0.250-inches. All steel components in tank 12 herein are joined, and integrated into a whole tank, by conventional welding.

It is also possible to use aluminum in place of steel.

Formed, as by spraying, on and all over the outside surface, 14a, of tank wall 14, and indicated generally at 20, is a three-layer, self-sealing, anti-puncture-wound-fuel-leak barrier coating including the three layers shown at 20a (inner), 20b (intermediate), 20c (outer) in FIGS. 2 and 3. Each of these layers is made up principally of a suitable, high-elastomeric, liquid-fuel-reactive material which responds to contact with any puncture-produced fuel leakage from tank 12 with what is referred to as elastomeric and material-swelling manners as parts of its self-sealing behavior. For this elastomeric material, we have chosen, as a preferred material, the two-compound polyurethane elastomer product sold under the trademark TUFF STUFF® FR, made by Rhino Linings USA, Inc.—a company based in San Diego, Calif.

In the preferred embodiment of the invention now being described, inner layer 20a, has a thickness of about 0.250-inches, intermediate layer 20b, a thickness of about 0.250-inches, and outer layer 20c, a thickness of about 0.250-inches.

Intermediate layer 20b includes an embedded population of liquid fuel imbiber beads 20d. Beads 20d herein are made of the product known as IMB230300, produced by Imbibitive Technologies America, Inc. in Midland, Michigan. These beads preferably are blended, in any appropriate manner during a layer-20b-creation spraying operation, into the entraining elastomeric material so as to constitute about 20% by weight of the combined material which makes up layer 20b.

Focusing attention particularly on FIG. 1, indicated by dash-dot, dash-double-dot, and dash-triple-dot, lines 22, 24, 26, respectively, are three, different, wound-creating (three, related entry wounds are schematically illustrated) projectile trajectories, such as military bullet trajectories. These trajectories are illustrated herein in order to help describe and picture the differentially-armored performance of tank structure 10.

As can be seen, each of these trajectories has resulted in the production of a puncture wound in high-risk zone 16, and particularly in zone-16 tank-wall components 16b, 16c—the respectively produced puncture wounds therein being illustrated schematically by pairs of adjacent, small, oppositely flaring curved lines which represent inwardly-directed puncture-wound blossoms, or flowers, associated with the penetrations which have taken place in the material making up components 16b, 16c.

As can be seen, the three different “entry” trajectories are continued in FIG. 1 inwardly of the three, pictured puncture wounds. As so continued, they include evident, rebound-associated paths (not specifically labeled) within the tank structure, illustrating how, within tank 12, the armoring material in low-risk zone 18, and particularly that in zone-18 tank-wall components 18a, 18b, 18c, has “intercepted” the linear extensions, and the associated, angular, rebound/ricochet paths, of the entry-trajectory paths, to prevent the occurrences of any exit wound penetrations of the tank wall by deflecting the entry-wound-producing projectiles for eventual energy loss and settling within the inside of tank 12.

Regarding high-risk-zone entry wounds, coating 20 deals very handily, i.e., rapidly sealingly, with such wounds, such as with the three, entry wounds shown in FIG. 1, since the associated entry-wound flowers are inwardly directed—i.e., away from this coating.

A preferred and best-mode embodiment of, and manner of practicing, the present invention have thus been described and illustrated.

Structurally, the invention proposes differentially-armored, altered-armoring-priority, liquid fuel tank structure for a vehicle—structure which embodies a reverse concept respecting the usual, traditional employment and positioning of fuel tank armoring structure. In this unique armoring reversal condition—a condition which results in both distinctively lightweight structure in the “field of armoring”, and significant materials-usage savings, the tank structure of the invention takes the form of a central, liquid fuel tank having a defining tank wall possessing an outside surface, and both a high-puncture-risk, entry-wound zone, and a low-puncture-risk, exit-wound zone. In association, respectively, with these two, different zones, the tank wall features integrated, functionally differentiated, tank-wall regions that are joined to one another, and that include, in a “reverse-thinking manner”, for the high-puncture-risk entry-wound zone, a region formed of lightweight, non-armoring material, and for the low-puncture-risk exit-wound zone, a region formed of heavyweight, armoring material.

Distributed over the entirety of the tank wall's outside surface is a self-sealing, anti-puncture-wound-leak, barrier coating formed throughout with a high-elastomeric material which reacts in elastomeric, and material-swelling, self-sealing manners on contact with leakage fuel coming from the tank.

This tank structure is created via a methodology which includes forming for the entry-wound zone a tank-wall region utilizing lightweight, non-armoring material, forming for the exit-wound zone another, joined, tank-wall region utilizing heavyweight, anti-penetration, armoring material, and jacketing the tank-wall's outside surface with a self-sealing, anti-puncture-wound-leak, barrier coating as just described.

Important features and advantages that are offered by the invention in relation to its reverse-concept character have been explained, and it will be appreciated that the exact configurational makeup of a fuel tank structure having the kinds of differentiated armoring zones and regions described may be varied appropriately to fit different installation conditions and situations. For example, it is entirely possible that high-puncture risk regions in tank might be relatively small in size and/or few in number, and given expected entry-wound trajectories in relation to such a condition, the positioning and sizing of low-puncture-risk armoring material would be adjusted accordingly to deal with such a situation. Given this thought, it should be clear that what is specifically illustrated in FIG. 1 in the drawings is simply a one-case representation of armoring-material and non-armoring-material dispositions in a liquid fuel tank.

Accordingly, and while, as has just been mentioned, a preferred and best mode embodiment of, and manner of practicing, the invention have been presented specifically herein, and certain thoughts given respecting the introduction of variations to fit different kinds of installation situations, we fully appreciate that other variations and modifications may be made which will come within the scope and spirit of the appended claims to invention.

We claim:

1. Differentially-armored, altered-armoring-priority, liquid fuel tank structure for a vehicle comprising
a liquid fuel tank having a defining tank wall possessing an outside surface, and both a high-puncture-risk, entry-wound zone, and a low-puncture-risk, exit-wound zone, and in association respectively with said zones, integrated, functionally differentiated, tank-wall regions joined to one another, and including, for said entry-wound zone, a region formed of lightweight, non-armoring material, and for said exit-wound zone, a region formed of heavyweight, armoring material, and
distributed over the entirety of said outside surface, a self-sealing, anti-puncture-wound-leak, barrier coating formed throughout with a high-elastomeric material which reacts in elastomeric and material-swelling self-sealing manners on contact with leakage fuel coming from said tank.

2. The tank structure of claim 1 wherein said barrier coating includes plural layers. and in at least one of said layers, a distribution of liquid-fuel imbiber beads.

3. A method for creating a differentially-armored, altered-armoring-priority, vehicle liquid-fuel tank structure possessing a tank with a wall having an outside surface, and characterized by contiguous, united and integrated, functionally differentiated, a high-puncture-risk, entry-wound and a low-puncture-risk, exit-wound zones, said method comprising
forming for the entry-wound zone a tank-wall region utilizing lightweight, non-armoring material,
forming for the exit-wound zone, in joinder with the first-mentioned formed tank-wall region, another tank-wall region utilizing heavyweight, anti-penetration, armoring material, and
jacketing the tank-wall's outside surface with a self-sealing, anti-puncture-wound-leak, barrier coating formed throughout with a high-elastomeric material which reacts in both elastomeric and material-swelling self-sealing manners on contact with leakage fuel coming from the tank.

4. The method of claim 3 which further comprises performing said jacketing so as to create plural layers in the barrier coating, and including in at least one of these layers, during jacketing, a distribution of liquid-fuel imbiber beads.
